(19) United States
(12) Patent Application Publication
(10) Pub. No.: US 2025/0270373 A1
(43) Pub. Date: Aug. 28, 2025

(54) AQUEOUS DISPERSIONS

(71) Applicant: AXALTA COATING SYSTEMS IP CO., LLC, Wilmington, DE (US)

(72) Inventors: Stephen Istivan, Havertown, PA (US); Carmen Flosbach, Wuppertal (DE); Eric C. Houze, Mullica Hill, NJ (US); Sylas LaPlante, Philadelphia, PA (US)

(73) Assignee: AXALTA COATING SYSTEMS IP CO., LLC, Wilmington, DE (US)

(21) Appl. No.: 19/061,324

(22) Filed: Feb. 24, 2025

Related U.S. Application Data
(60) Provisional application No. 63/558,842, filed on Feb. 28, 2024.

(51) Int. Cl. C08J 3/05; C08J 3/20; C08J 3/21; C08J 3/215; C08K 3/04; C08K 3/34

(52) U.S. Cl. CPC C08J 3/05; C08J 3/203; C08J 3/212; C08J 3/215; C08K 3/041; C08K 3/34; C08J 2333/06; C08J 2467/00; C08J 2475/04; C08J 2479/08; C08K 2201/001; C08K 2201/003; C08K 2201/004; C08K 2201/006

(57) ABSTRACT

Conductive aqueous dispersions for application as coatings, and methods for producing conductive aqueous dispersions are provided. In an embodiment, a method for producing a conductive aqueous dispersion includes mixing water, solvent, and binder to form a homogenous mixture. Further, the method includes adding carbon nanotubes to the homogenous mixture and mixing at high shear to form the dispersion.

### CROSS-REFERENCE TO RELATED APPLICATION

This application claims the benefit of U.S. Provisional Application No. 63/558,842, filed Feb. 28, 2024, which is hereby incorporated in its entirety by reference.

### TECHNICAL FIELD

The technical field generally relates to aqueous dispersions, and more particularly relates to conductive aqueous dispersions comprising a carbon nanotubes or use as coatings.

### BACKGROUND

Electrically conductive coatings are typically formed on non-conductive substrates by either a dry or a wet process. In the dry process, Physical Vapor Deposition (PVD) (including sputtering, ion plating and vacuum deposition) or Chemical Vapor Deposition (CVD) is used to form a conductive coating of a metal oxide type. In the wet process, a conductive coating composition is formed using an electrically conductive powder of mixed oxides and a binder which forms a dispersion.

A significant discovery and improvement in the creation of conductive inks, dyes and coatings was that of carbon nanotubes, which are essentially single graphite layers wrapped into tubes, either single walled nanotubes, double walled (DWNTs) or multi walled (MWNTs) wrapped in several concentric layers. Carbon nanotubes are readily synthesized and commercially available. Carbon nanotubes have good intrinsic electrical conductivity and have been used to form conductive materials.

It is desirable to provide coatings or paints with enhanced qualities such as would be appropriate for automobiles or other vehicles. In particular, it is desirable to provide coatings or paints with low resistivity. Further, it is desirable to form aqueous dispersions of binders and carbon nanotubes that are of suitable composition to be sprayed onto automotive body parts.

### SUMMARY

Conductive aqueous dispersions for application as coatings, and methods for producing conductive aqueous dispersions are provided. In an embodiment, a method for producing a conductive aqueous dispersion includes mixing water, solvent, and binder to form a homogenous mixture. Further, the method includes adding carbon nanotubes to the homogenous mixture and mixing at high shear to form the dispersion.

In another embodiment, a conductive aqueous dispersion is provided. The aqueous dispersion includes water, solvent, binder, and carbon nanotubes. In the aqueous dispersion, the carbon nanotubes are conductive, and the dispersion includes from about 5 to about 20% conductive material based on total binder solids.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### DETAILED DESCRIPTION

The following detailed description is merely exemplary in nature and is not intended to limit the compositions and methods as described herein. Furthermore, there is no intention to be bound by any theory presented in the preceding background or summary or in the following detailed description.

As used herein, “a,” “an,” or “the” means one or more unless otherwise specified. The term “or” can be conjunctive or disjunctive. Open terms such as “include,” “including,” “contain,” “containing” and the like mean “comprising.” In certain embodiments, numbers in this description indicating amounts, ratios of materials, physical properties of materials, and/or use are may be understood as being modified by the word “about”. The term “about” as used in connection with a numerical value and the claims denotes an interval of accuracy, familiar and acceptable to a person skilled in the art. In general, such interval of accuracy is ±10%. All numbers in this description indicating amounts, ratios of materials, physical properties of materials, and/or use may be understood as being modified by the word “about” or may be understood as being not modified by the word “about”. As used herein, the “%” or “percent” described in the present disclosure refers to the weight percentage unless otherwise indicated.

As noted above, conductive aqueous dispersions are provided herein for use in application as a coating or paint onto substrates such as automotive body parts. Exemplary aqueous dispersions include conductive carbon nanotubes.

### EXAMPLES

### Control Example 1

A four-liter reactor was fitted with a steel propeller-agitated mixer and filled with deionized (DI) water (60%), Ethylene Glycol Monobutylether (3.08%), Heavy Naphtha (1.37%), Dipropylene Glycol Monobutyl Ether (1.37%). While mixing (at a temperature of from 20 to 25° C.), the solid resins, binders and additives (excluding the CNTs) were added slowly to the solvents and homogenized for an additional thirty minutes with medium shear. After the binder was completely homogenized, the homogenous mixture was transferred to a high shear disperser equipped with a stainless steel saw tooth propeller. A conductive dispersion was then produced by adding 1.13% Carbon Nanotubes (CNTs) while mixing at high shear for approximately forty-five minutes to form the resultant dispersion.

TABLE A
Control Example 1

| | Parts |
|---|---|
| Component | by weight |
| Deionized Water | 60.00 |
| Ethylene Glycol Monobutylether | 3.08 |
| Heavy Naphtha | 1.37 |
| Dipropylene Glycol Monobutyl Ether | 1.37 |
| Acrylic Resin - Example 1 of | 11.43 |
| U.S. Pat. No. 7,825,173 | |
| Polyester Resin - Example 5 of 10,233,353 | — |
| Urethane Resin - Example 2a of | 10.37 |
| U.S. Pat. No. 9,688,877 | |
| Melamine-Formaldehyde Resin | 3.41 |
| Amine | 0.14 |
| Magnesium Silicate | 7.36 |
| Defoamer | 0.34 |
| Carbon Nanotubes | 1.13 |
| Total | 100.00 |
| % Conductive Material Based on Binder Solids | 10 |

### Control Example 2

A four-liter reactor was fitted with a steel propeller-agitated mixer and filled with DI water (61.21%), Ethylene Glycol Monobutylether (2.94%), Heavy Naphtha (1.31%), Dipropylene Glycol Monobutyl Ether (1.31%). While mixing (at a temperature of from 20 to 25° C.), the solid resins, binders and additives (excluding the CNTs) were added slowly to the solvents and homogenized for an additional thirty minutes with medium shear. After the binder is completely homogenized, it is transferred to a high shear disperser, equipped with a stainless steel saw tooth propeller. A conductive dispersion was then produced by adding 1.63% Carbon Nanotubes (CNTs) when mixing at high shear and the resultant dispersion was mixed for approximately forty-five minutes.

TABLE B
Control Example 2

| | Parts |
|---|---|
| Component | by weight |
| Deionized Water | 61.21 |
| Ethylene Glycol Monobutylether | 2.94 |
| Heavy Naphtha | 1.31 |
| Dipropylene Glycol Monobutyl Ether | 1.31 |
| Acrylic Resin - Example 1 of | 10.93 |
| U.S. Pat. No. 7,825,173 | |
| Polyester Resin - Example 5 of 10,233,353 | — |
| Urethane Resin - Example 2a of | 9.92 |
| U.S. Pat. No. 9,688,877 | |
| Melamine-Formaldehyde Resin | 3.26 |
| Amine | 0.13 |
| Magnesium Silicate | 7.03 |
| Defoamer | 0.33 |
| Carbon Nanotubes | 1.63 |
| Total | 100.00 |
| % Conductive Material Based on Binder Solids | 15 |

### Example 3

A four-liter reactor was fitted with a steel propeller-agitated mixer and filled with DI water (60.62%), Ethylene Glycol Monobutylether (3.07%), Heavy Naphtha (1.37%), Dipropylene Glycol Monobutyl Ether (1.37%). While mixing (at a temperature of from 20 to 25° C.), the solid resins, binders, additives and the experimental polyester resin #1 (excluding the CNTs) were added slowly to the solvents and homogenized for an additional thirty minutes with medium shear. After the binder is completely homogenized, it is transferred to a high shear disperser, equipped with a stainless steel saw tooth propeller. A conductive dispersion was then produced by adding 1.14% Carbon Nanotubes (CNTs) when mixing at high shear and the resultant dispersion was mixed for approximately forty-five minutes.

TABLE C
Example 3

| | Parts |
|---|---|
| Component | by weight |
| Deionized Water | 60.62 |
| Ethylene Glycol Monobutylether | 3.07 |
| Heavy Naphtha | 1.37 |
| Dipropylene Glycol Monobutyl Ether | 1.37 |
| Acrylic Resin - Example 1 of | 11.41 |
| U.S. Pat. No. 7,825,173 | |
| Polyester Resin - Example 5 of 10,233,353 | 2.86 |
| Urethane Resin - Example 2a of | 6.93 |
| U.S. Pat. No. 9,688,877 | |
| Melamine-Formaldehyde Resin | 3.40 |
| Amine | 0.14 |
| Magnesium Silicate | 7.35 |
| Defoamer | 0.34 |
| Carbon Nanotubes | 1.14 |
| Total | 100.00 |
| % Conductive Material Based on Binder Solids | 10 |

### Example 4

A four-liter reactor was fitted with a steel propeller-agitated mixer and filled with DI water (61.77%), Ethylene Glycol Monobutylether (2.94%), Heavy Naphtha (1.31%), Dipropylene Glycol Monobutyl Ether (1.31%). While mixing (at a temperature of from 20 to 25° C.), the solid resins, binders, additives and the experimental polyester resin #1 (excluding the CNTs) were added slowly to the solvents and homogenized for an additional thirty minutes with medium shear. After the binder is completely homogenized, it is transferred to a high shear disperser, equipped with a stainless steel saw tooth propeller. A conductive dispersion was then produced by adding 1.14% Carbon Nanotubes (CNTs) when mixing at high shear and the resultant dispersion was mixed for approximately forty-five minutes.

TABLE D
Example 4

| | Parts |
|---|---|
| Component | by weight |
| Deionized Water | 61.77 |
| Ethylene Glycol Monobutylether | 2.94 |
| Heavy Naphtha | 1.31 |
| Dipropylene Glycol Monobutyl Ether | 1.31 |
| Acrylic Resin - Example 1 of | 10.92 |
| U.S. Pat. No. 7,825,173 | |
| Polyester Resin - Example 5 of 10,233,353 | 2.74 |
| Urethane Resin - Example 2a of | 6.63 |
| U.S. Pat. No. 9,688,877 | |
| Melamine-Formaldehyde Resin | 3.25 |
| Amine | 0.13 |
| Magnesium Silicate | 7.03 |
| Defoamer | 0.33 |
| Carbon Nanotubes | 1.64 |
| Total | 100.00 |
| % Conductive Material Based on Binder Solids | 15 |

For Comparative Examples 1-2 and Examples 3-4, binder solids were measured using a Computrac MAX 4000xL, available from Ametek of Brookfield, USA, following the procedure of ASTM D7232-06.

As indicated, the acrylic resin composition is defined in Example 1 of U.S. Pat. No. 7,825,173, which is incorporated by reference herein in its entirety. In the examples herein, the acrylic resin composition has a content of 46.3% total solids.

As indicated, the polyester resin composition is defined in Example 5 in U.S. Pat. No. 10,233,353, which is incorporated by reference herein in its entirety. In the examples herein, the polyester resin composition has a content of 43.7% total solids.

As indicated, the urethane resin composition is defined in Example 2a of U.S. Pat. No. 9,688,877, which is incorporated by reference herein in its entirety. In the examples herein, the urethane resin composition has a content of 35.3% total solids.

The surface resistivity of coated articles formed with coatings from Examples 1-4 was analyzed for comparison. Specifically, surface resistivity of four coated articles was measured with a ‘Prostat PRS-801 Resistance System’ (Prostat Corporation of Glendale Heights, Illinois, USA) following the procedure of ASTM D4496, which provides for the determination of the measurement of electrical resistance or conductance of materials that are generally categorized as moderately conductive and are neither good electrical insulators nor good conductors. In ASTM D4496, test measurements of electrical resistance (or conductance) and specimen geometry data are used to compute an electrical resistivity for the material. This test method applies to all materials that exhibit surface resistivity in the range of 103 to 107 (per square). This test method is designed for measurements at standard conditions of 23 C and 50% relative humidity, but its principles of operation can be applied to specimens measured at lower or higher temperatures and relative humidities.

Table E presents results of the surface resistivity testing of articles formed with coatings from Examples 1-4:

TABLE E
Surface Resistivity measured according to ASTM D4496

| | Coated | Coated | | |
|---|---|---|---|---|
| | Article | Article | Coated | Coated |
| | by Control | by Control | Article by | Article by |
| | Example 1 | Example 2 | Example 3 | Example 4 |
| Surface | 80 | 30 | 32 | 12 |
| Resistivity | | | | |
| (ohms per square) | | | | |

Surface resistivity is the resistance to leakage current along the surface of an insulating material. As shown, articles coated by the compositions of Example 3 and Example 4 exhibit improved surface resistivity (lower values are indicative of better resistivity).

Examples 1-4 have the following estimated compositions.

TABLE F
Compositions

| | Example 1 | Example 2 | Example 3 | Example 4 |
|---|---|---|---|---|
| Estimate % | 5.26 | 5.03 | 5.25 | 5.02 |
| acrylic (g resin/ | | | | |
| 100 g wet paint) | | | | |
| Estimate % PE | 0.00 | 0.00 | 1.03 | 0.99 |
| Estimate % | 3.63 | 3.47 | 2.43 | 2.32 |
| Polyurethane | | | | |
| Estimate % | 2.73 | 2.61 | 2.72 | 2.60 |
| Melamine | | | | |

### Example 5

A four liter reactor was fitted with a steel propeller-agitated mixer and filled with DI water (74.26%), Dipropylene Glycol Methyl Ether (0.58%), Dipropylene Glycol Monobutyl Ether (0.58%), Heavy Naptha (0.73%), Diethylene Glycol Monobutyl Ether (0.35%). While mixing (20-25° C.), the solid resins, binders and additives (excluding the Carbon Nanotubes) were added slowly to the solvents and homogenized for an additional thirty minutes with medium shear. After the binder was completely homogenized, it was transferred to a high shear disperser, equipped with a stainless steel saw tooth propeller. A conductive dispersion was then produced by adding 1.13% Carbon Nanotubes (CNTs) when mixing at high shear and the resultant dispersion was

TABLE G
Example 5

| | Parts |
|---|---|
| Component | by weight |
| Amine | 0.25 |
| Acrylic Resin - Example 1 of | 13.28 |
| U.S. Pat. No. 7,825,173 (46.3% total solids) | |
| DI Water | 74.26 |
| Dipropylene Glycol Methyl Ether (Eastman) | 0.58 |
| Defoamer | 0.16 |
| Dipropylene Glycol Monobutyl Ether (Eastman) | 0.58 |
| Heavy Naphtha | 0.73 |
| Melamine-Formaldehyde Resin | 3.44 |
| Diethylene Glycol Monobutyl Ether | 0.35 |
| Hindered Amine Light Stabilizer | 0.15 |
| Adhesion Promoter | 0.16 |
| Silicone surface additive (BYK-333) | 0.03 |
| Silicone Surfactant (BYK-347) | 0.20 |
| Polyester Resin - Example 5 of | 2.09 |
| 10,233,353 (43.7% total solids) | |
| Urethane Resin - Example 2a of | 2.61 |
| U.S. Pat. No. 9,688,877 (35.3% total solids) | |
| Carbon Nanotubes | 1.13 |
| Total | 100.00 |
| % Conductive Material Based on Binder Solids | 10 |

### Example 6

A four liter reactor was fitted with a steel propeller-agitated mixer and filled with DI water (74.78%), Dipropylene Glycol Methyl Ether (0.56%), Dipropylene Glycol Monobutyl Ether (0.56%), Heavy Naptha (0.70%), Diethylene Glycol Monobutyl Ether (0.34%). While mixing (20-25° C.), the solid resins, binders and additives (excluding the Carbon Nanotubes) were added slowly to the solvents and homogenized for an additional thirty minutes with medium shear. After the binder was completely homogenized, it was transferred to a high shear disperser, equipped with a stainless steel saw tooth propeller. A conductive dispersion was then produced by adding 1.63% Carbon Nanotubes (CNTs) when mixing at high shear and the resultant dispersion was

TABLE H
Example 6

| | Parts |
|---|---|
| Component | by weight |
| Amine | 0.24 |
| Acrylic Resin - Example 1 of | 12.71 |
| U.S. Pat. No. 7,825,173 (46.3% total solids) | |
| DI Water | 74.78 |
| Dipropylene Glycol Methyl Ether (Eastman) | 0.56 |
| Defoamer | 0.16 |
| Dipropylene Glycol Monobutyl Ether (Eastman) | 0.56 |
| Heavy Naphtha | 0.70 |
| Melamine-Formaldehyde Resin | 3.29 |
| Diethylene Glycol Monobutyl Ether | 0.34 |
| Hindered Amine Light Stabilizer | 0.15 |
| Adhesion Promoter | 0.16 |
| Silicone surface additive (BYK-333) | 0.03 |
| Silicone Surfactant (BYK-347) | 0.19 |
| Polyester Resin - Example 5 of | 2.00 |
| 10,233,353 (43.7% total solids) | |
| Urethane Resin - Example 2a of | 2.50 |
| U.S. Pat. No. 9,688,877 (35.3% total solids) | |
| Carbon Nanotubes | 1.63 |
| Total | 100.00 |
| % Conductive Material Based on Binder Solids | 15 |

### Example 7

A four liter reactor was fitted with a steel propeller-agitated mixer and filled with DI water (74.00%), Dipropylene Glycol Methyl Ether (0.55%), Dipropylene Glycol Monobutyl Ether (0.55%), Heavy Naptha (0.69%), Diethylene Glycol Monobutyl Ether (0.33%). While mixing (20-25° C.), the solid resins, binders and additives (excluding the Carbon Nanotubes) were added slowly to the solvents and homogenized for an additional thirty minutes with medium shear. After the binder was completely homogenized, it was transferred to a high shear disperser, equipped with a stainless steel saw tooth propeller. A conductive dispersion was then produced by adding 1.17% Carbon Nanotubes (CNTs) when mixing at high shear and the resultant dispersion was

TABLE I
Example 7

| | Parts |
|---|---|
| Component | by weight |
| Amine | 0.25 |
| Acrylic Resin - Example 1 of | 5.37 |
| U.S. Pat. No. 7,825,173 (46.3% total solids) | |
| Hybrid Resin - U.S. patent | 10.94 |
| application Ser. No. 17/446,059 | |
| DI Water | 74.00 |
| Dipropylene Glycol Methyl Ether (Eastman) | 0.55 |
| Defoamer | 0.15 |
| Dipropylene Glycol Monobutyl Ether (Eastman) | 0.55 |
| Heavy Naphtha | 0.69 |
| Melamine-Formaldehyde Resin | 3.23 |
| Diethylene Glycol Monobutyl Ether | 0.33 |
| Hindered Amine Light Stabilizer | 0.14 |
| Adhesion Promoter | 0.15 |
| Silicone surface additive (BYK-333) | 0.03 |
| Silicone Surfactant (BYK-347) | 0.19 |
| Polyester Resin - Example 5 of | 0.66 |
| 10,233,353 (43.7% total solids) | |
| Urethane Resin - Example 2a of | 1.60 |
| U.S. Pat. No. 9,688,877 (35.3% total solids) | |
| Carbon Nanotubes | 1.17 |
| Total | 100.00 |
| % Conductive Material Based on Binder Solids | 10 |

### Example 8

A four liter reactor was fitted with a steel propeller-agitated mixer and filled with DI water (74.55%), Dipropylene Glycol Methyl Ether (0.52%), Dipropylene Glycol Monobutyl Ether (0.52%), Heavy Naptha (0.66%), Diethylene Glycol Monobutyl Ether (0.32%). While mixing (20-25° C.), the solid resins, binders and additives (excluding the Carbon Nanotubes) were added slowly to the solvents and homogenized for an additional thirty minutes with medium shear. After the binder was completely homogenized, it was transferred to a high shear disperser, equipped with a stainless steel saw tooth propeller. A conductive dispersion was then produced by adding 1.68% Carbon Nanotubes (CNTs) when mixing at high shear and the resultant dispersion was

TABLE J
Example 8

| | Parts |
|---|---|
| Component | by weight |
| Amine | 0.24 |
| Acrylic Resin - Example 1 of | 5.14 |
| U.S. Pat. No. 7,825,173 (46.3% total solids) | |
| Hybrid Resin - U.S. patent | 10.47 |
| application Ser. No. 17/446,059 | |
| DI Water | 74.55 |
| Dipropylene Glycol Methyl Ether (Eastman) | 0.52 |
| Defoamer | 0.15 |
| Dipropylene Glycol Monobutyl Ether (Eastman) | 0.52 |
| Heavy Naphtha | 0.66 |
| Melamine-Formaldehyde Resin | 3.09 |
| Diethylene Glycol Monobutyl Ether | 0.32 |
| Hindered Amine Light Stabilizer | 0.14 |
| Adhesion Promoter | 0.15 |
| Silicone surface additive (BYK-333) | 0.03 |
| Silicone Surfactant (BYK-347) | 0.18 |
| Polyester Resin - Example 5 of | 0.63 |
| 10,233,353 (43.7% total solids) | |
| Urethane Resin - Example 2a of | 1.53 |
| U.S. Pat. No. 9,688,877 (35.3% total solids) | |
| Carbon Nanotubes | 1.68 |
| Total | 100.00 |
| % Conductive Material Based on Binder Solids | 15 |

For Examples 5-8, binder solids were measured using a Computrac MAX 4000xL, available from Ametek of Brookfield, USA, following the procedure of ASTM D7232-06.

Table K presents results of the surface resistivity testing of articles formed with coatings from Examples 5-8:

TABLE E
Surface Resistivity measured according to ASTM D4496

| | Coated | Coated | Coated | Coated |
|---|---|---|---|---|
| | Article by | Article by | Article by | Article by |
| | Example 5 | Example 6 | Example 7 | Example 8 |
| Surface | 18 | 13 | 22 | 15 |
| Resistivity | | | | |
| (ohms per square) | | | | |

Examples 5-8 were evaluated for performance in coating an article. For example, surface resistivity was measured with a ‘PROSTAT PRS-801 RESISTANCE SYSTEM’ (PROSTAT CORPORATION, USA). Following the procedure for ASTM D4496. Surface resistivity is the resistance to leakage current along the surface of an insulating material. According to the testing parameters, a lower value is indicative of better coating performance.

Examples 5-8 have the following estimated compositions.

TABLE L
Compositions

| | Example 5 | Example 6 | Example 7 | Example 8 |
|---|---|---|---|---|
| Estimate % | 5.31 | 5.08 | 8.17 | 7.81 |
| acrylic (g resin/ | | | | |
| 100 g wet paint) | | | | |
| Estimate % PE | 3.03 | 2.90 | 6.16 | 5.89 |
| Estimate % | 0.00 | 0.00 | 0.00 | 0.00 |
| Polyurethane | | | | |
| Estimate % | 2.75 | 2.63 | 2.58 | 2.47 |
| Melamine | | | | |

### Carbon Nanotubes

The carbon nanotubes are provided and mixed into the composition as a solid material, such as in pellet form. Exemplary carbon nanotubes are conductive coated, branched and crosslinked carbon structures. Exemplary carbon nanotubes have a pellet size of 5 mm length by 1 mm diameter, a bulk density of 0.135 g/cm³ (ASTM D7481), a surface area of 200 m²/g (ASTM D6556), and a carbon content of 97%. Exemplary carbon nanotubes are commercially available under the mark Athlos™ from Cabot Corporation of Boston, Mass.

In exemplary embodiments, the aqueous dispersion has a total carbon nanotube content of at least 0.1 wt. %, such as at least 0.5 wt. %, for example at least 0.6 wt. %, such as at least 0.7 wt. %, for example at least 0.8 wt. %, such as at least 0.9 wt. %, for example at least 1.0 wt. %, such as at least 1.1 wt. %, for example at least 1.2 wt. %, such as at least 1.3 wt. %, for example at least 1.4 wt. %, such as at least 1.5 wt. %, for example at least 1.6 wt. %, such as at least 1.7 wt. %, for example at least 1.8 wt. %, such as at least 1.9 wt. %, for example at least 2.0 wt. %. An exemplary aqueous dispersion has a total carbon nanotube content of at most 5 wt. %, such as at most 2.5 wt. %, for example at most 2.4 wt. %, such as at most 2.3 wt. %, for example at most 2.2 wt. %, such as at most 2.1 wt. %, for example at most 2.0 wt. %, such as at most 1.9 wt. %, for example at most 1.8 wt. %, such as at most 1.7 wt. %, for example at most 1.6 wt. %, such as at most 1.5 wt. %, for example at most 1.4 wt. %, such as at most 1.3 wt. %, for example at most 1.2 wt. %, such as at most 1.1 wt. %, for example at most 1.0 wt. %.

In exemplary embodiments, the carbon nanotubes are the only source of conductive material in the aqueous dispersion. An exemplary aqueous dispersion has a conductive material content, based on binder solids, of at least 5 wt. %, such as at least 6 wt. %, for example at least 7 wt. %, such as at least 8 wt. %, for example at least 9 wt. %, such as at least 10 wt. %, for example at least 11 wt. %, such as at least 12 wt. %, for example at least 13 wt. %, such as at least 14 wt. %, for example at least 15 wt. %. An exemplary aqueous dispersion has a conductive material content, based on binder solids, of at most 25 wt. %, such as at most 20 wt. %, for example at most 19 wt. %, such as at most 18 wt. %, for example at most 17 wt. %, such as at most 16 wt. %, for example at most 15 wt. %, such as at most 14 wt. %, for example at most 13 wt. %, such as at most 12 wt. %, for example at most 11 wt. %, such as at most 10 wt. %, for example at most 9 wt. %, such as at most 8 wt. %. As described herein, binder solids may be measured following the procedure of ASTM D7232-06.

### Water

In exemplary embodiments, the aqueous dispersion has a total water content of at least 40 wt. %, such as at least 45 wt. %, for example at least 50 wt. %, such as at least 52.5 wt. %, for example at least 55 wt. %, such as at least 57.5 wt. %, for example at least 60 wt. %, such as at least 62.5 wt. %, for example at least 65 wt. %. An exemplary aqueous dispersion has a total water content of at most 75 wt. %, such as at most 70 wt. %, for example at most 65 wt. %, such as at most 60 wt. %, for example at most 55 wt. %, such as at most 50 wt. %, for example at most 45 wt. %, such as at most 40 wt. %, for example at most 35 wt. %, such as at most 30 wt. %, for example at most 25 wt. %.

### Solvents

In exemplary embodiments, the aqueous dispersion has a total solvent content of at least 2 wt. %, such as at least 2.5 wt. %, for example at least 3 wt. %, such as at least 3.5 wt. %, for example at least 4 wt. %, such as at least 4.5 wt. %, for example at least 5 wt. %, such as at least 5.5 wt. %, for example at least 6 wt. %. An exemplary aqueous dispersion has a solvent content of at most 10 wt. %, such as at most 8 wt. %, for example at most 7.5 wt. %, such as at most 7 wt. %, for example at most 6.5 wt. %, such as at most 6 wt. %, for example at most 5.5 wt. %, such as at most 5 wt. %, for example at most 4.5 wt. %, such as at most 4 wt. %.

The aqueous dispersion may include conventional organic solvents. Examples of such solvents are alcohols, for example, propanol, butanol, hexanol, 2-ethyl hexanol, benzyl alcohol, isodecanol; glycol ethers, for example, diethylene glycol di-C1-C6-alkyl ether, dipropylene glycol di-C1-C6-alkyl ether, ethoxypropanol, methoxypropanol, butyl glycol, butoxypropanol, butyl diglycol, hexyl glycol, methoxybutanol; glycol ether esters, for example, methoxypropyl acetate, butyl glycol acetate, butyl diglycol acetate; glycols, for example, ethylene glycol and/or propylene glycol, and the di- or trimers thereof; ketones, such as, methyl ethyl ketone, methyl isobutyl ketone, acetone, cyclohexanone, 4-hydroxy-4-methyl-2-pentanone; terpene, aromatic or aliphatic hydrocarbons, for example, toluene, xylene or linear or branched aliphatic C6-C12 hydrocarbons.

Exemplary solvents include ethylene glycol monobutylether, dipropylene glycol monobutyl ether, and heavy naphtha, though other suitable solvents may be used.

### Binder

In exemplary embodiments, the aqueous dispersion has a total binder content of at least 10 wt. %, such as at least 11 wt. %, for example at least 12 wt. %, such as at least 13 wt. %, for example at least 14 wt. %, such as at least 15 wt. %, for example at least 16 wt. %, such as at least 17 wt. %, for example at least 18 wt. %, such as at least 19 wt. %, for example at least 20 wt. %, such as at least 21 wt. %, for example at least 22 wt. %, such as at least 23 wt. %, for example at least 24 wt. %, such as at least 25 wt. %, for example at least 26 wt. %, such as at least 27 wt. %, for example at least 28 wt. %, such as at least 29 wt. %, for example at least 30 wt. %. In exemplary embodiments, the aqueous dispersion has a total binder content of at most 35 wt. %, such as at most 34 wt. %, for example at most 33 wt. %, such as at most 32 wt. %, for example at most 31 wt. %, such as at most 30 wt. %, for example at most 29 wt. %, such as at most 28 wt. %, for example at most 27 wt. %, such as at most 26 wt. %, for example at most 25 wt. %, such as at most 24 wt. %, for example at most 23 wt. %, such as at most 22 wt. %, for example at most 21 wt. %, such as at most 20 wt. %, for example at most 19 wt. %, such as at most 18 wt. %, for example at most 17 wt. %, such as at most 16 wt. %, for example at most 15 wt. %.

In exemplary embodiments, the binder includes a plurality of different resins. For example the aqueous dispersion may include acrylic resins, polyester resins, urethane resins, acrylic/(meth)acryl copolymer hybrid resins, and/or urethanized polyester/(meth)acryl copolymer hybrid resins, and mixtures thereof.

### Acrylic Resin

An exemplary binder is an acrylic resin, such as the acrylic resin produced according to Example 1 of U.S. Pat. No. 7,825,173.

In exemplary embodiments, the aqueous dispersion has a total acrylic resin content of at least 2.5 wt. %, such as at least 5 wt. %, for example at least 6 wt. %, such as at least 7 wt. %, for example at least 8 wt. %, such as at least 9 wt. %, for example at least 10 wt. %, such as at least 10.5 wt. %, for example at least 11 wt. %, such as at least 11.5 wt. %, for example at least 12 wt. %. In exemplary embodiments, the aqueous dispersion has a total acrylic resin content of at most 20 wt. %, such as at most 15 wt. %, for example at most 14.5 wt. %, such as at most 14 wt. %, for example at most 13.5 wt. %, such as at most 13 wt. %, for example at most 12.5 wt. %, such as at most 12 wt. %, for example at most 11.5 wt. %, such as at most 11 wt. %, for example at most 10.5 wt. %, such as at most 10 wt. %, for example at most 8 wt. %, such as at most 5 wt. %.

Certain embodiments herein have an acrylic composition of at least 2%, such as at least 2.5%, at least 3%, at least 3.5%, at least 4%, at least 4.5%, at least 5%, at least 5.5%, at least 6%, at least 6.5%, at least 7%, or at least 7.5%. Further, such embodiments may have an acrylic composition of no more than 10%, such as no more than 9.5%, no more than 9%, no more than 8.5%, no more than 8%, no more than 7.5%, no more than 7%, no more than 6.5%, no more than 6%, no more than 5.5%, or no more than 5%. Some embodiments have an acrylic composition of from 5.0% to 8.2%.

### Polyester Resin

An exemplary binder is a polyester resin, such as the polyester resin produced according to Example 5 of U.S. Pat. No. 10,233,353. In exemplary embodiments, the aqueous dispersion has a total polyester resin content of at least 0.5 wt. %, such as at least 1 wt. %, for example at least 1.5 wt. %, such as at least 2 wt. %, for example at least 2.2 wt. %, such as at least 2.4 wt. %, for example at least 2.5 wt. %, such as at least 2.6 wt. %, for example at least 2.7 wt. %, such as at least 2.8 wt. %, for example at least 2.9 wt. %, such as at least 3 wt. %. In exemplary embodiments, the aqueous dispersion has a total polyester resin content of at most 4 wt. %, such as at most 3.5 wt. %, for example at most 3.0 wt. %, such as at most 2.9 wt. %, for example at most 2.8 wt. %, such as at most 2.7 wt. %, for example at most 2.6 wt. %, such as at most 2.5 wt. %, for example at most 2 wt. %, such as at most 1.5 wt. %, for example at most 1 wt. %.

Certain embodiments herein have a polyester composition of at least 0.5%, such as at least 1%, at least 1.5%, at least 2%, at least 2.5%, at least 3%, at least 3.5%, at least 4%, at least 4.5%, at least 5%, at least 5.5%, or at least 6%. Further, such embodiments may have a polyester composition of no more than 10%, such as no more than 9.5%, no more than 9%, no more than 8.5%, no more than 8%, no more than 7.5%, no more than 7%, no more than 6.5%, no more than 6%, or no more than 5.5%, no more than 5%, no more than 4.5%, no more than 4%, no more than 3.5%, no more than 3%, no more than 2.5%, or no more than 2%. Some embodiments have a polyester composition of from 1.0% to 6.2%. As indicated in Control Examples 1 and 2, a composition with zero polyester exhibits worse resistivity performance.

### Polyurethane Resin

An exemplary binder is a urethane resin, such as the urethane resin produced according to Example 2a of U.S. Pat. No. 9,688,877.

In exemplary embodiments, the aqueous dispersion has a total urethane resin content of at least 0.5 wt. %, such as at least 1 wt. %, for example at least 1.5 wt. %, such as at least 2 wt. %, for example at least 2.5 wt. %, such as at least 3 wt. %, for example at least 3.5 wt. %, such as at least 4 wt. %, for example at least 4.5 wt. %, such as at least 5 wt. %, for example at least 5.5 wt. %, such as at least 6 wt. %, for example at least 6.1 wt. %, such as at least 6.2 wt. %, for example at least 6.3 wt. %, such as at least 6.4 wt. %, for example at least 6.5 wt. %, such as at least 6.6 wt. %, for example at least 6.7 wt. %, such as at least 6.8 wt. %, for example at least 6.9 wt. %, such as at least 7 wt. %. In exemplary embodiments, the aqueous dispersion has a total urethane resin content of at most 10 wt. %, such as at most 9 wt. %, for example at most 8 wt. %, such as at most 7.5 wt. %, for example at most 7 wt. %, such as at most 6.9 wt. %, for example at most 6.8 wt. %, such as at most 6.7 wt. %, for example at most 6.6 wt. %, such as at most 6.5 wt. %, for example at most 6 wt. %.

Certain embodiments herein include no polyurethane. In embodiments including polyurethane, those embodiments may have a polyurethane composition of at least 0.1% such as at least 0.5%, at least 1%, at least 1.5%, at least 2%, at least 2.5%, at least 3%, or at least 3.5%. Further, such embodiments may have a polyurethane composition of no more than 5%, such as no more than 4.5%, no more than 4%, no more than 3.5%, no more than 3%, no more than 2.5%, no more than 2%, no more than 1.5%, no more than 1%, or no more than 0.5%, or no more than 0.1%.

### Hybrid Resin

An exemplary binder is the urethanized polyester/(meth)acryl copolymer hybrid resin (“hybrid resin”) produced according to U.S. patent application Ser. No. 17/446,059, filed Aug. 26, 2021 and incorporated by reference herein in its entirety. In exemplary embodiments, the aqueous dispersion has a total hybrid resin content of at least 1 wt. %, for example at least 5 wt. %, such as at least 10 wt. %, for example at least 20 wt. %, such as at least 30 wt. %, for example at least 40 wt. %, such as at least 50 wt. %, for example at least 60 wt. %, such as at least 70 wt. %, or for example at least 75 wt. %. In exemplary embodiments, the aqueous dispersion has a total hybrid resin content of at most 80 wt. %, such as at most 75 wt. %, for example at most 65 wt. %, such as at most 55 wt. %, for example at most 45 wt. %, such as at most 35 wt. %, for example at most 25 wt. %, such as at most 20 wt. %, for example at most 15 wt. %, such as at most 10 wt. %, for example at most 5 wt. %. In certain embodiments, the aqueous dispersion has a total hybrid resin content of from 10 to 50%.

### Crosslinkers

The aqueous dispersion contemplated herein may contain one or more conventional crosslinkers in a proportion corresponding to a solids contribution of 0 to about 40 wt. % of the resin solids of the aqueous dispersion. Examples of such crosslinkers include aminoplast resins, interesterification crosslinkers and crosslinkers with free or reversibly blocked isocyanate groups. Examples of aminoplast resins include benzoguanamine resins and, in particular, melamine resins. Examples of interesterification crosslinkers include trisalkoxycarbonylaminotriazines. Examples of crosslinkers with free or reversibly blocked isocyanate groups include the conventional free or blocked polyisocyanate crosslinkers known as crosslinkers for coating compositions.

### Melamine Resin

An exemplary crosslinker is a melamine-formaldehyde resin. In exemplary embodiments, the aqueous dispersion has a total melamine-formaldehyde resin content of at least 0.5 wt. %, such as at least 1 wt. %, for example at least 1.5 wt. %, such as at least 2 wt. %, for example at least 2.2 wt. %, such as at least 2.4 wt. %, for example at least 2.5 wt. %, such as at least 2.6 wt. %, for example at least 2.7 wt. %, such as at least 2.8 wt. %, for example at least 2.9 wt. %, such as at least 3 wt. %, for example at least 3.1 wt. %, such as at least 3.2 wt. %, for example at least 3.3 wt. %, such as at least 3.4 wt. %, for example at least 3.5 wt. %, such as at least 3.6 wt. %, for example at least 3.7 wt. %, such as at least 3.8 wt. %, for example at least 3.9 wt. %, such as at least 4 wt. %. In exemplary embodiments, the aqueous dispersion has a total melamine-formaldehyde resin content of at most 6 wt. %, such as at most 5 wt. %, for example at most 4.5 wt. %, such as at most 4.2 wt. %, for example at most 4 wt. %, such as at most 3.9 wt. %, for example at most 3.8 wt. %, such as at most 3.7 wt. %, for example at most 3.6 wt. %, such as at most 3.5 wt. %, for example at most 3.4 wt. %, such as at most 3.3 wt. %, for example at most 3.2 wt. %, such as at most 3.1 wt. %, for example at most 3.0 wt. %, such as at most 2.9 wt. %, for example at most 2.8 wt. %.

Certain embodiments herein have a melamine composition of at least 0.5%, such as at least 1%, at least 1.5%, at least 2%, at least 2.5%, at least 3%, at least 3.5%, at least 4%, at least 4.5%, at least 5%, at least 5.5%, or at least 6%. Further, such embodiments may have a melamine composition of no more than 10%, such as no more than 9.5%, no more than 9%, no more than 8.5%, no more than 8%, no more than 7.5%, no more than 7%, no more than 6.5%, no more than 6%, or no more than 5.5%, no more than 5%, no more than 4.5%, no more than 4%, no more than 3.5%, no more than 3%, no more than 2.5%, or no more than 2%. Some embodiments have a melamine composition of from 2.5% to 2.8%.

### Additives

In exemplary embodiments, the aqueous dispersion includes additives, such as neutralizing agents, fillers, and defoamers, as well as other desired and suitable additives. Examples are wetting agents, adhesion promoters, catalysts, levelling agents, anticratering agents, rheology control agents, for example, thickeners, and light stabilizers, for example, UV absorbers and/or HALS-based compounds (HALS, hindered amine light stabilizers).

An exemplary neutralizing agent may be selected from amines and/or aminoalcohols, though any suitable neutralizing agent may be used. In an exemplary embodiment, the aqueous dispersion has a total neutralizing agent content of at least 0.01 wt. %, such as at least 0.05 wt. %, for example at least 0.08 wt. %, such as at least 0.1 wt. %, for example at least 0.11 wt. %, such as at least 0.12 wt. %, for example at least 0.13 wt. %, such as at least 0.14 wt. %, for example at least 0.15 wt. %. In exemplary embodiments, the aqueous dispersion has a total neutralizing agent content of at most 0.5 wt. %, such as at most 0.4 wt. %, for example at most 0.3 wt. %, such as at most 0.25 wt. %, for example at most 0.2 wt. %, such as at most 0.18 wt. %, for example at most 0.15 wt. %, such as at most 0.13 wt. %, for example at most 0.1 wt. %.

An exemplary filler is magnesium silicate, though any suitable filler may be used. Examples are barium sulfate, kaolin, talcum, silicon dioxide, and layered silicates. In an exemplary embodiment, the aqueous dispersion has a total filler content of at least 3 wt. %, such as at least 4 wt. %, for example at least 5 wt. %, such as at least 6 wt. %, for example at least 7 wt. %, such as at least 8 wt. %, for example at least 9 wt. %, such as at least 10 wt. %. In exemplary embodiments, the aqueous dispersion has a filler content of at most 12 wt. %, such as at most 11 wt. %, for example at most 10 wt. %, such as at most 9 wt. %, for example at most 8 wt. %, such as at most 7 wt. %, for example at most 6 wt. %, such as at most 5 wt. %.

In an exemplary embodiment, the aqueous dispersion has a total defoamer content of at least 0.1 wt. %, such as at least 0.2 wt. %, for example at least 0.25 wt. %, such as at least 0.3 wt. %, for example at least 0.33 wt. %, such as at least 0.34 wt. %, for example at least 0.35 wt. %. In exemplary embodiments, the aqueous dispersion has a defoamer content of at most 0.5 wt. %, such as at most 0.4 wt. %, for example at most 0.35 wt. %, such as at most 0.34 wt. %, for example at most 0.33 wt. %, such as at most 0.3 wt. %.

### Pigments

The aqueous dispersion may include one or more conventional pigments or special effect pigments, including pigments selected from among white, colored and black pigments. Examples of white, colored and black pigments are the conventional inorganic or organic pigments known to the person skilled in the art, such as, for example, titanium dioxide, iron oxide pigments, carbon black, azo pigments, phthalocyanine pigments, quinacridone pigments, pyrrolopyrrole pigments, and perylene pigments. Examples of special effect pigments are conventional pigments which impart to a coating color flop and/or lightness flop dependent on the angle of observation, such as, non-leafing metal pigments, for example, of aluminum, copper or other metals, interference pigments, such as, for example, metal oxide-coated metal pigments, for example, iron oxide-coated aluminum, coated mica, such as, for example, titanium dioxide-coated mica, graphite effect-imparting pigments, iron oxide in flake form, liquid crystal pigments, coated aluminum oxide pigments, coated silicon dioxide pigments.

The aqueous dispersion can be applied to and form a coating or film on a substrate, and in particular automotive substrates like automobile bodies, automobile body parts or other automotive parts. Automotive substrates can be plastics or metal substrates or so-called mixed construction substrates comprising plastics as well as metal. As already said, the automotive substrates may be automotive bodies or automotive body parts; automotive bodies can be metal substrates or mixed construction substrates, while automotive body parts can be metal substrates, plastics substrates or mixed construction substrates. Automotive plastics substrates may be uncoated or they may have a precoating.

In exemplary embodiments, the aqueous dispersion is spray applied on to the substrate to form a layer or film thereon. The spray application may be performed by any conventional spray application method; in case of OEM coating the typical spray application method is electrostatically-assisted high speed rotary atomization and it may be carried out so as to spray-apply the aqueous dispersion in one or more than one spray passes, each of which is performed by electrostatically-assisted high speed rotary atomization. The overall film thickness of the layer, which may be comprised of two or more coating layers or sublayers, may be in the range of, for example, about 7 to about 40 m. The film thicknesses indicated herein for coating layers refer in each case to dry film thicknesses.

Application of the aqueous dispersion can be followed by a drying procedure, in particular a brief flash-off phase of, for example, about 30 seconds to about 30 minutes at an air temperature of about 20 to about 100° C., after which overlying coating compositions may be spray-applied to form overlying layers.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

What is claimed is:

1. A method for producing a conductive aqueous dispersion, the method comprising:
mixing water, solvent, and binder to form a homogenous mixture; and
adding carbon nanotubes to the homogenous mixture and mixing at high shear to form the dispersion.

2. The method of claim 1 wherein the carbon nanotubes are conductive, and wherein the dispersion includes from about 5 to about 20% conductive material based on total binder solids.

3. The method of claim 1 wherein the carbon nanotubes are conductive, and wherein the dispersion includes from about 10 to about 15% conductive material based on total binder solids.

4. The method of claim 1 wherein the dispersion is formed with a carbon nanotube content of about 0.5 to about 2.5 wt. %, based on the total weight of the dispersion.

5. The method of claim 1 wherein the dispersion is formed with a carbon nanotube content of about 1.0 to about 1.8 wt. %, based on the total weight of the dispersion.

6. The method of claim 1 wherein the dispersion is formed by:
grafting a first acrylic resin component and a polyester resin component to one another; and
grafting a second acrylic resin component and a urethane resin component to one another.

7. The method of claim 1, wherein the dispersion is formed with:
a total acrylic resin content of about 5 to 8.2 wt. %;
a total polyester resin content of about 1 to about 6.2 wt. %;
a total urethane resin content of up to about 3.7 wt. %

8. The method of claim 1 wherein the dispersion is formed with a binder content of about 16 to about 33 wt. %, based on the total weight of the dispersion.

9. The method of claim 1 wherein the binder comprises:
acrylic resin;
polyester resin;
urethane resin; and
melamine formaldehyde resin.

10. The method of claim 1, wherein the dispersion is formed with:
an acrylic resin content of about 5 to 8.2 wt. %;
a polyester resin content of about 1 to about 6.2 wt. %;
a urethane resin content of about 0.0 to 3.7 wt. %; and
a melamine formaldehyde resin content of about 2.5 to about 2.8 wt. %;
based on the total weight of the dispersion.

11. The method of claim 1, further comprising mixing filler with the water, solvent, and binder to form the homogenous mixture.

12. The method of claim 11, wherein the filler is magnesium silicate.

13. The method of claim 11, wherein the dispersion is formed with a filler content of about 5 to about 10 wt. %, based on the total weight of the dispersion.

14. The method of claim 1, further comprising mixing defoamer with the water, solvent, and binder to form the homogenous mixture.

15. The method of claim 14, wherein the dispersion is formed with a defoamer content of about 0.2 to about 0.5 wt. %, based on the total weight of the dispersion.

16. The method of claim 1, further comprising mixing neutralizing agent with the water, solvent, and binder to form the homogenous mixture.

17. The method of claim 16, wherein the neutralizing agent is amine.

18. The method of claim 16, wherein the dispersion is formed with a neutralizing agent content of about 0.05 to about 0.25 wt. %, based on the total weight of the dispersion.

19. A conductive aqueous dispersion comprising:
water;
solvent;
binder; and
carbon nanotubes; wherein the carbon nanotubes are conductive, and wherein the dispersion includes from about 5 to about 20% conductive material based on total binder solids.

20. The conductive aqueous dispersion of claim 19, wherein the dispersion has:
a carbon nanotube content of about 0.5 to about 2.5 wt. %, based on the total weight of the dispersion;
a water content of about 50 to about 70 wt. %, based on the total weight of the dispersion;
a solvent content of about 4 to about 8 wt. %, based on the total weight of the dispersion; and
a binder content of about 16 to about 33 wt. %, based on the total weight of the dispersion.
